(19) United States
(12) Patent Application Publication
(10) Pub. No.: US 2011/0254344 A1
(43) Pub. Date: Oct. 20, 2011

(54) Wheelchair Seat Belt Cover Device

(76) Inventors: Cheryl Freeman, Meridian, ID (US); Argyle White, Meridian, ID (US)

(21) Appl. No.: 13/087,460

(22) Filed: Apr. 15, 2011

Related U.S. Application Data
(60) Provisional application No. 61/324,400, filed on Apr. 15, 2010.

(51) Int. Cl. B60R 22/00; A62B 35/00

(52) U.S. Cl. 297/482

(57) ABSTRACT

A padded segment device for wheelchair restraint belts that functions to decrease chaffing, rash or other injury related to long-term wear. The device functions by wrapping a padded segment around restraint belts at critical contact points. Additionally, a system employing multiple padded segment devices used in conjunction with an open padded segment allows the practitioner to customize the device to any type of wheelchair design, including protection from and access to a restraint buckle.

### CROSS REFERENCE TO RELATED APPLICATION

This application claims the benefit of U.S. Provisional Application No. 61/324,400 filed on Apr. 15, 2010, entitled “Seatbelt Protector Cover.”

### BACKGROUND OF THE INVENTION

1. Field of the Invention

The present invention relates to a protective restraint covers. More specifically, the present invention relates to wheelchair restraint covers for the prevention of sores and irritations after prolonged use.

Some individuals using a wheelchair require a restraint or seatbelt to prevent accidents. These restraints assist the individual in maintaining their position within the chair and prevent sliding or falling. The restraint belts anchor to the body of the wheelchair and are subjected to tension, causing the restraint belt structure to bear against the user's body. Unfortunately, such restraints have a tendency to cause belt marks, blisters, and rashes on the patient's midsection following long periods of use. Rashes and irritations may further develop into sores, or even into infections. Individuals confined to wheelchairs are frequently more prone to health issues than the general population, so further stress from infections should be avoided. In addition to the systemic health risk, these sores may be extremely painful and can impede the practitioner's general lifestyle or path to recovery.

Further difficulty lies in connection with the hygiene of the restraint belts. Wheelchairs and restraints are may be used over an extended period and accordingly become worn and dirty as time passes. Continuous use without replacement or protective coverings can create dirty or soiled restraints, particularly with food particles and other debris. Even during non-use, restraint belts will become dusty and accumulate dirt and other substances that can discolor and soil one's clothing.

Thus, a more efficient and effective device is needed to assure the comfort, cleanliness and health of those who must make use of a wheel chair restraint for long-term periods. Further, such an invention should be adaptable to all manner of user body types and wheelchair restraint configurations.

2. Description of the Prior Art

Patents have been granted to several devices that attempt to address some of these problems in relation to restraints and automotive seatbelts. However, the prior art fails to provide an easy-to-use device or system that takes into account all of the foregoing issues and is adaptable for use with wheelchair restraints.

Several of the prior art patents are directed to simply making an automobile seatbelt more comfortable. Wold U.S. Pat. No. 4,678,205 is directed to a covering of comfortable material with means to be joined to the seat belt of a vehicle and then be readily moved to a position where it will be in contact with the user of the safety harness. The covering of comfortable material will automatically move to a storage position when the safety harness is released and retracted. Saenz U.S. Pat. No. 4,699,401 is directed to a removable seat belt cover including an elongated foldable length of material. The material includes a protective cushion portion adapted to surround a vehicle seat belt. Positioned on the material are releasable fastener elements to engage and retain the base material in position when folded about the seat belt portion.

Li U.S. Pat. No. 5,161,824 is directed to a safety belt with a protective pad comprising a belt body that is fixed inside a vehicle and guided to extend over a user's shoulder and is retractable into a storage bank. The Li patent also describes a protective pad made of a soft material, which is slidably attached to the belt so that during use the pad is movable to extend over the user's shoulder and chest to protect the user from chafe with the belt if the vehicle is violently jolted. Gianino U.S. Pat. No. 5,322,349 is directed to a seat belt cushion apparatus with removable padding is disclosed. The apparatus includes an envelope having an elongate case with an interior compartment formed therein and a flap carried by the case for selectively opening and closing the compartment. Padding is removeably received by the compartment when the flap is opened on one end.

The foregoing patents provide a device that increases the level of comfort of the traditional automobile seat belt, however, they do not account for the unique requirements of an individual who is bound to a wheelchair. These prior art devices fail to take into account the need for padding behind buckles, and further are only suitable for use with traditional lap and shoulder belts. Wheelchair restraint belts are located differently, and thus require different design considerations than the typical automotive seat belt.

Other prior art devices are decorative in nature. Weightman U.S. Pat. No. 4,741,574 is directed to a decorative cover for an automotive seat belt. The cover has a decorative outer surface. The long edges of the panel have fastening means of hook and loop fasteners. One of the fasteners is positioned slightly inward from the longitudinal edge of the panel such that when the panel is folded around an automotive seat belt a portion of the longitudinal edge extends beyond the fastener means so as not to chafe. Similarly, Kobayashi U.S. Pat. No. 6,922,876 is directed to a seat belt cover comprising a flat tubular member through which a seat belt of a motor vehicle is passed to be covered therewith. The seat belt cover can prevent the friction of a seat belt with clothes to keep the shoulder or breast of a coat or jacket from becoming shiny and wearing. Decorative devices fail to provide padding, and are simply for aesthetics or the protection of clothing. As such, these devices fail to address the issue of contact irritation, which the present invention addresses and prevents.

These prior art devices suffer from several drawbacks. In particular, each is designed for a car seat belt and not intended for continuous, prolonged wheelchair usage. The prior art is not intended to provide comfort for users spending extended periods restrained. As such, imbedded padding is either limited or non-existent. Further, the prior art does not take into account any type of belt beyond the traditional seat belt. Wheelchair restraint belts are typically more involved and diverse in their design and construction. At a minimum, both shoulders are restrained and often there are additional straps, such as a sternum strap. To account for the diversity of design, the present invention allows multiple shorter padded segments to attach together with an intervening open padded segment. This allows the practitioner to assure that the covering device does not obscure buckles or other necessary access points, while also providing padding across the buckle interface.

The present invention is designed for patients in wheelchairs that require restraint belts and functions as a protective cover system that is placed over the seatbelt in locations that cross the patient's body. The present invention effectively protects the patient from incurring blisters, rashes, sores, belt marks, and other irritations caused by the restraint belts. It eliminates potential harm to the individual's midsection and offers a comfortable alternative to traditional utilitarian wheelchair restraint belts.

### SUMMARY OF THE INVENTION

In view of the foregoing disadvantages inherent in the known types of seat belt strap covers now present in the prior art, the present invention provides a new wheelchair seatbelt restraint cover wherein the same can be utilized for providing convenience for the user when operating a wheelchair device.

It is therefore an object of the present invention to provide a padded device capable of acting as a cushion to ease the irritation, injury or discomfort for the operator when wearing a restraint belt for an extended period. Another object of the present invention is to provide a system of protectively attachable padding segments adaptable to the restraint belts of any wheelchair. A further object of the present invention is to protect the restraint belts from soiling over time, by covering them with an easily removable and cleanable cover. Still another object of the present invention is to provide a restraint belt padding system that is easily attachable and removable to selected portions of the restraint belts, with the attachment means being in the form of mating Velcro type hook and loop fastener strips or other means. The removable restraint belt padding of the present invention can be formed of a single material or a combination of materials.

It is a further object of the invention to provide a system of padding based on segments that fasten along the longitudinal side. A hook and loop strip or other attachment means may be used to secure segments of the device along the wheelchair restraint belt. The segments of the device may each attach via hook and loop strips or other attachment means to open padded segments, allowing continuous padding behind restraint buckles. A modular system of fully covered segments and open padding allows the practitioner to adjust locations of the wheelchair padding to suit their build and wheelchair type.

Other objects, features and advantages of the present invention will become apparent from the following detailed description taken in conjunction with the accompanying drawings.

### BRIEF DESCRIPTIONS OF THE DRAWINGS

FIG. 1 is a perspective view of the present invention in use by a wheelchair bound practitioner.

FIG. 2 is a perspective view of the padded segments of the present invention.

### DETAILED DESCRIPTION OF THE INVENTION

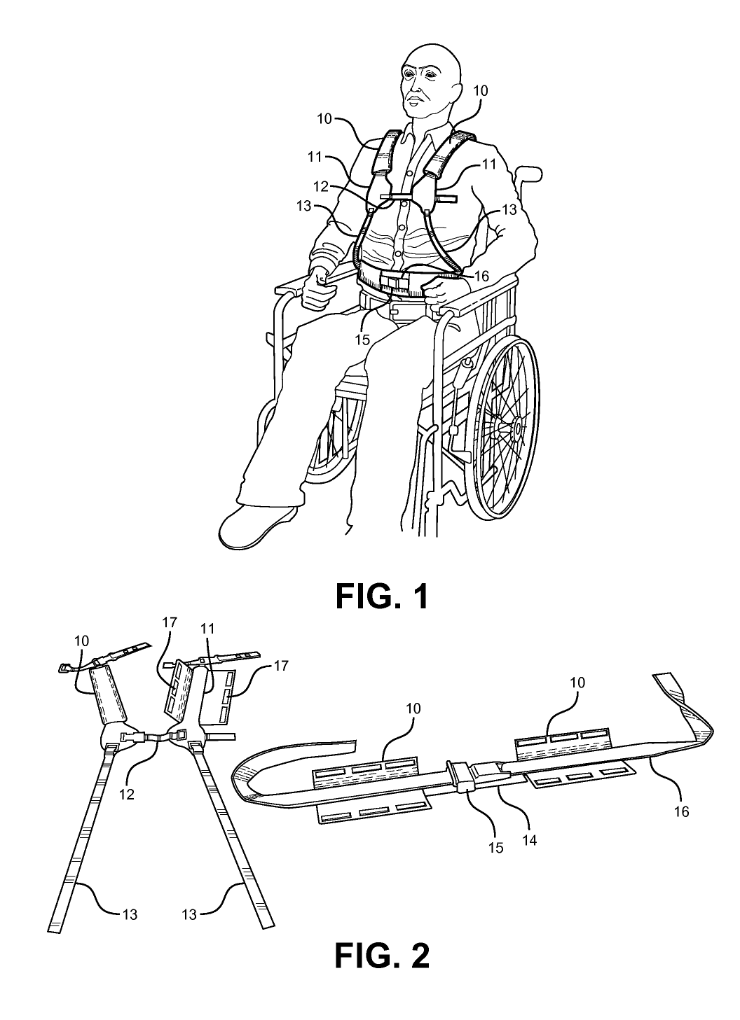

Referring now to FIG. 1, there is shown a perspective view of the present invention in use. The present invention comprises padded segments 10 encompassing the shoulder restraint straps 11 of the wheelchair. Additional padded segments may be used to pad the sternum strap 12 and the lower torso straps 13. Further, padded segments 10 may be joined with an open padded segment 14 to allow restraint buckles 15 to be accessed from the front while protecting the user from the backside of the buckle. The present invention can be customized to fit a variety of wheelchair restraint systems by combining padded segments 10 and open padded segments 14.

Referring now to FIG. 2, there is shown a perspective view of the padded segments of the present invention. The padded segments 10 are each equipped with one or a plurality of attachment means 17 along the longitudinal side. Said foldable padded segments may be attached to the shoulder straps 11, the sternum strap 12, the lower torso strap 13 or any other strap that comes into contact with the practitioner. Further, padded segments 10 may attach to open padded segments 14 to maintain padding behind restraint buckles 15 while still allowing access. This interconnectivity allows the segments to pad straps with buckles, such as the waist strap 16, while allowing the buckles to be accessed when needed.

In use, the present invention provides comfort to individuals who require extended use of a wheelchair with restraints. The present invention consists of foldable padded segments 10 made from fleece, cotton, or other material deemed suitable by one skilled in the art. The foldable padded segments 10 may be wrapped around the restraint belt of a wheelchair to provide protection from irritation and affixed using an attachment means along the longitudinal side. The foldable padded segment 10 may include one or a plurality of attachment means, such as hook and loop fasteners or snaps, which secure the foldable padded segment 10 around the restraint belt. Other means of attachment 17 may be substituted if deemed suitable. The end of a foldable padded segment 10 may also attach to an open padded segment 14 allowing extension of the padding behind restraint belt buckles 15 while still allowing access to the buckle. The padded segments 10 may be available in a variety of colors to accommodate user preferences.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A segmented pad device for enhancing the comfort and protecting users from wheelchair restraint belts comprising:
a foldable pad segment having two opposed and substantially parallel longitudinal edges and an interior cavity adapted to accept a layer of protective padding therein;
said foldable pad segment adapted to surround a selected portion of a restraint belt when said segment is folded thereabout;
said foldable pad segment includes a releasable attachment means capable of fastening said longitudinal edges together to securely encircle said restraint belt.

2) A device, as in claim 1, further comprising an attachment means at each lateral end of said pad segment.

3) A device, as in claim 1, wherein a first and second foldable pad segment are joined together at their ends via a strip of padded material, said strap of material adapted to rest behind a restraint buckle and allow access thereof, said pad segments adapted to surround sections of a restraint belt on both sides of said buckle.

4) An interchangeable system of segmented pad devices for enhancing the comfort and protecting users of wheelchair restraint belts comprising:
a plurality of foldable pad segments having two opposed and substantially parallel longitudinal edges and an interior cavity adapted to accept a layer of protective padding therein;
said foldable pad segments adapted to surround portions of a restraint belt when said segment is folded thereabout;
said foldable pad segments include a releasable attachment means capable of fastening said longitudinal edges together to securely encircle said restraint belt;
said plurality of pad segments are joined together at their ends via a strip of padded material;
said strap of material adapted to rest behind a restraint buckle and allow access thereof, said pad segments adapted to surround sections of a restraint belt on both sides of said buckle.
